(19) United States
(12) Patent Application Publication
(10) Pub. No.: US 2026/0065733 A1
(43) Pub. Date: Mar. 5, 2026

(54) CONTROL METHOD AND SYSTEM FOR IDENTITY AND AGE VERIFICATION OF AN INDIVIDUAL FOR A LOCKER BANK

(71) Applicant: TQG, Inc., Palo Alto, CA (US)

(72) Inventor: Neil Biafore, San Francisco, CA (US)

(21) Appl. No.: 19/380,399

(22) Filed: Nov. 5, 2025

Related U.S. Application Data
(63) Continuation of application No. PCT/US2024/027588, filed on May 3, 2024.
(60) Provisional application No. 63/464,401, filed on May 5, 2023.
(60) Provisional application No. 63/521,597, filed on Jun. 16, 2023.
(60) Provisional application No. 63/606,825, filed on Dec. 6, 2023.

(51) Int. Cl. G07C 9/33; G06Q 30/0601; G07C 9/00; G07C 9/38

(52) U.S. Cl. CPC G07C 9/33; G07C 9/00912; G07C 9/38; G06Q 30/0607

(57) ABSTRACT

The present disclosure involves systems, software, and computer implemented methods for age-restricted access to a locker bank. An example method includes receiving an indication from an agent computing device at a physical location that an age and identity of a user requesting pickup of an age-restricted item have been verified. The physical location includes a locker that includes the item. An unlock code is generated for the user for the item in response to receiving the indication. The unlock code is provided to a user computing device and to a locker system. A user-provided unlock code is received at the locker system. The locker system verifies that the user-provided unlock code has not expired and matches the generated unlock code. An unlocking of the locker for the user is triggered in response to determining that the user-provided code matches the generated code.

### CLAIM OF PRIORITY

This application is a continuation application to U.S. Patent Application Ser. Number PCT/US2024/027588, filed on May 3, 2024, which claims priority to U.S. Patent Application Ser. No. 63/606,825, filed on Dec. 6, 2023, U.S. Patent Application No. 63/521,597, filed Jun. 16, 2023 and U.S. Patent Application Ser. No. 63/464,401, filed on May 5, 2023, the entire contents of which are hereby incorporated by reference.

### TECHNICAL FIELD

The present disclosure relates to computer-implemented methods, software, and systems for controlling access to a locker bank based on age and identity restrictions.

### BACKGROUND

Parcel lockers can be used for product delivery for retail orders. After a user has purchased a product (e.g., online or over the phone), the product can be placed into a parcel locker for pickup. The user can be notified that the item is available in the parcel locker. The user can proceed to the parcel locker and retrieve the item from the parcel locker.

### SUMMARY

The present disclosure involves systems, software, and computer implemented methods for controlling access to a locker bank based on age restrictions. An example method includes: receiving an indication from an agent computing device of an agent at a physical location that an age and identity of a first user requesting pickup of a first age-restricted item have been verified, wherein the physical location includes a locker system that includes a first locker that includes the first age-restricted item that was delivered to the first locker; generating an unlock code for the first user for the first age-restricted item in response to receiving the indication that the age and identity of the first user have been verified; providing the unlock code to a user computing device and to the locker system; receiving, at the locker system and from the first user, a user-provided unlock code; verifying, by the locker system, that the user-provided unlock code has not expired and matches the unlock code previously-provided to the locker system; and triggering an unlocking of the first locker for the first user in response to determining that the unlock code received from the first user matches the unlock code previously-provided to the locker system.

Implementations may include one or more of the following features. The indication received from the agent computing device can indicate that the agent has verified the age and identity of the first user by visually verifying identification provided by the first user. The indication received from the agent computing device can include an image of the identification provided by the first user. The indication received from the agent computing device can include the age or a birth date of the first user entered by the agent into a user interface of the agent computing device. The indication received from the agent computing device can include an identification type of the identification provided by the first user. Identification types can include driver license, other state-issued identification, or military-issued identification. The unlock code can be generated by a central server or by the locker system. The unlock code can be provided to the agent computing device. The unlock code can be provided to the user computing device using a SMS (Simple Message Service) message, an in-application message, an electronic mail message, or a push message. The unlock code can be received at the locker system as touch inputs of an input device of the locker system. The unlock code can be received at the locker system in response to receiving an image of the unlock code at an image scanner of the locker system. The unlock code can be received at the locker system over a wireless network from the user computing device. The generated unlock code can be provided to the locker system for verification in response to the locker system requesting the unlock code after the locker system receives the user-provided unlock code. A secondary verification of identification provided by the user can be performed. The secondary verification can include automatically extracting a user birth date of the first user from an image of the identification and automatically verifying the age of the user based on the extracted birth date. The secondary verification can include analyzing an image of the identification to verify authenticity of the identification. Information can be logged in response to the triggering of the unlocking of the first locker. A request can be received from the agent computing device to regenerate a new unlock code. A second unlock code can be generated in response to the request to regenerate the new unlock code and the second unlock code can be provided to the user computing device, the agent computing device, and the locker system.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for controlling access to a parcel locker for age-restricted items.

FIGS. 2-5 illustrate example user interfaces.

FIG. 6 illustrates an example flowchart of a process for controlling access to a parcel locker for age-restricted items.

FIGS. 7-12 illustrate example wireframes and user interfaces associated with example implementations of the solution.

FIG. 13 illustrates an example flowchart of a process for controlling access to a parcel locker for age-restricted items.

FIG. 14 is a block diagram illustrating an example of a computer-implemented system used to provide computational functionalities associated with described algorithms, methods, functions, processes, flows, and procedures, according to an implementation of the present disclosure.

### DETAILED DESCRIPTION

Historically, parcel lockers have been used for drop-off/pickup locations for retail orders. Some merchants may desire to use parcel lockers for age-restricted products. However, security measures should be in place to ensure that the user retrieving the item from the parcel locker meets an age requirement. In current solutions, age-restricted items may be difficult to manage and place in parcel lockers, as inadequate security may be in place, which can allow unauthorized or under-age users to purchase goods remotely, and then pick up themselves without oversight. A control method described herein can be used as an appropriate security measure to confirm the age, as well as the identity, of an individual attempting to retrieve an age-restricted item from a parcel locker.

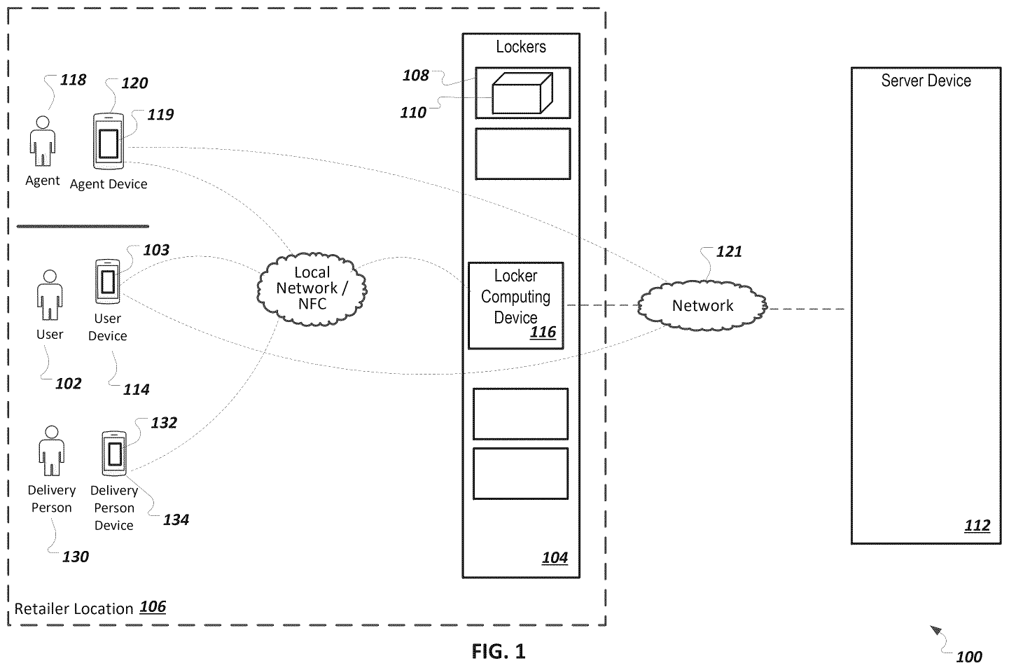

FIG. 1 is a block diagram illustrating an example system 100 for controlling access to a parcel locker for age-restricted items. A user 102 of a merchant (e.g., an online merchant, or a retailer providing remote orders available for pickup, etc.) can order an age-restricted product (e.g., online, over the phone, etc.). The merchant can establish a relationship with a brick-and-mortar retailer for delivery of age-restricted products to a locker bank 104 at a retailer location 106 of the retailer. As another example, the merchant and the retailer may be the same entity. The age-restricted product ordered by the user 102 can be delivered to the retailer location 106 and placed into a locker 108 (e.g., as illustrated by a delivered item 110).

In some cases, the solution described herein can be used for person-to-person transactions, for example person-to-person transactions that are managed by a third party. In some cases, identification verification to trigger locker opening may be performed for transactions other than age-restricted transactions. For instance, for transactions that have a purchase value greater than a predefined amount, the person picking up the item may be required to find and provide identification to an agent for agent identification verification (or participate in other types of verification approaches as described herein) in order to obtain a code to unlock the locker.

As one example of an age-restricted product purchase, the merchant may be a wine seller that sells wine using an e-commerce website. The retailer may be, for example, a pharmacy chain and the retailer location 106 may be a particular brick-and-mortar pharmacy. The locker bank 104 may be used for delivery of wine by the wine seller and for delivery of products sold by other merchants. Some of the products sold by the merchant and other merchants may be age-restricted, such as alcohol or other age-restricted products. The locker bank 104 can be also used for delivery of products that are not age-restricted, where at least some non-age-restricted products can be obtained without requiring in-person verification of age and identity.

After the item 110 has been placed into the locker 108, a server device 112 (or some other computing system or server) can send a notification to the user 102 regarding availability of the item 110 for pickup. The server device 112 can be associated with a central entity that manages and controls user pickup of age-restricted items from parcel lockers such as the locker bank 104. In some instances, the server device 112 may be part of a cloud-based network of computers or servers, where the server device 112 executes remote from the locker 108.

The user 102 can receive and view the notification on a user device 114 (e.g., a mobile device), such as in a user application 103 provided by the central entity, as a text message, an e-mail message, etc. The notification can instruct the user 102 to proceed to the retailer location 106 to retrieve the item 110.

In some cases, the notification may instruct the user 102 to proceed to the locker bank 104. The locker bank 104 includes a locker computing device 116 that can include a display and one or more input devices (e.g., touch screen, keyboard). The user 102 can, for example, enter a code provided in the notification (e.g., an order number, a code along with an order number, or some other code, etc.) at the locker computing device 116. In different implementations, the user may enter an initial code (and also an unlock code as described below) using a touch screen interface of the locker computing device 116, a physical keyboard of the locker computing device, scanning a code using a scanner connected to or part of the locker computing device 116, or using, for example, NFC (Near Field Communication) by sending a code from the user device 114 to the locker computing device 116.

Based on the item 110 being an age-restricted item (or based on an order for multiple items including at least one age-restricted item), the locker computing device 116 can display a message informing the user 102 to find an employee at the retailer location 106 (e.g., an agent 118), where the user 102 can complete an identity and age verification process with the agent 118 prior to obtaining the items. If the item 110 is not an age-restricted item, the locker computing device 116 can, upon receiving a code from the user 102, trigger an unlock of the locker 108 to enable the user 102 to retrieve the item 110. For age-restricted items, however, the locker computing device 116 can be configured to instruct the user 102 to perform the age-verification process with the agent 118, where the unlock code (which is a different code than an initial code that may have been included with the initial delivery notification sent to the user 102) is only available after successful completion of the process.

Different approaches can be used to configure the locker computing device 116 to handle retrieval of age-restricted items such as the item 110. For instance, in some implementations, the server device 112 can download information to the locker computing device 116 (e.g., about delivery of the item 110) and, after the information is downloaded, the locker computing device 116 can manage the retrieval of the item 110. In other implementations, the locker computing device 116 may send various types of requests to the server device 112 (e.g., about order/item type (age-restricted, not-age-restricted), confirmation of item location, etc.). For example, in some implementations, in response to a user entering an order or item number at the locker computing device 116, the locker computing device 116 sends a request to the server device 112 to inquire as to whether the item (or an item in the order) is in fact stored in the locker bank and whether the item is age-restricted. In some cases, the locker computing device 116 can send other messages to the server device 112 regarding an unlock process, as described below. In some cases, a combination of approaches can be used. For instance, the locker computing device 116 can use an offline mode or an online mode to perform its operations. If communication with the server device 112 is interrupted or not available, then the offline mode can be used. When a connection with the server device 112 is available (e.g., over a network 121), an online mode that includes message passing to/from the server device 112 can be used.

In some cases, the initial delivery notification sent to the user 102 may instruct the user to find an employee (e.g., the agent 118) at the retailer location 106 to initiate pickup of the item 110. In some cases, the locker computing device 116 does not have a dynamic display. In such cases, physical, static signage on the locker bank 104 may instruct the user 102 to find an agent for age verification (and in such cases, such instructions may generally be also sent to the user 102/user device 114 as part of delivery notification). In either case, the item 110 may not be retrievable at the locker bank 104 until the additional unlock code is obtained.

As another example, the user 102 may generally approach the agent 118 about order pickup before proceeding to the locker bank 104. In response to the user 102 inquiring with the agent 118 about order pickup, the agent 118 may ask the user 102 for an order number. The agent 118 may select or search for the order number using an agent application 119 displayed and executed on an agent device 120. The agent device 120 may be a mobile device used by the agent 118, for example. The agent application 119 may be provided by the central entity, for example. In some cases, the agent application 119 may run on a point-of-sale system available at the retailer location 106. The agent application 119 can be used to verify the user's age and identity.

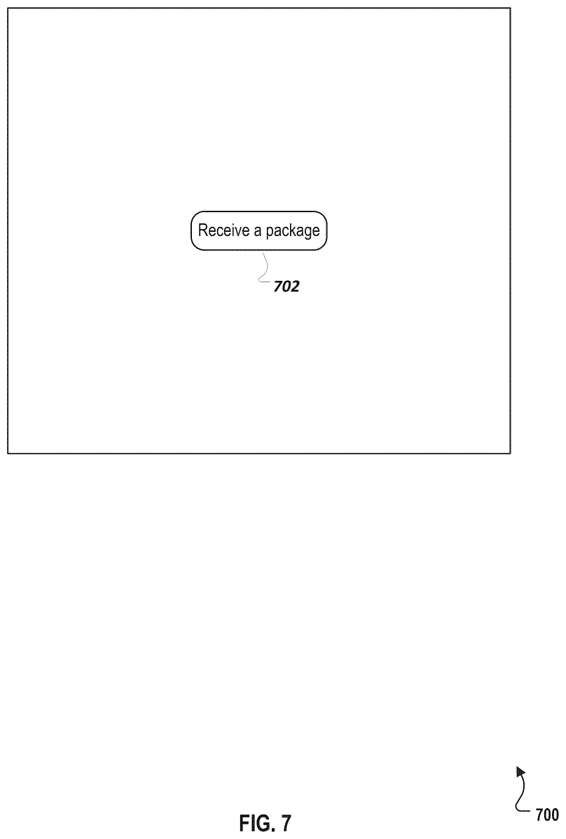

In general, various approaches can be used for initial setting of the unlock code for the locker 108. In some cases, the server device 112 can interact with the locker computing device 116 to set the unlock code for the locker 108. As another example, the agent 118 and/or a delivery person 130 can interact with the locker 108 and/or the locker computing device 116 to set the unlock code for the locker 108, either by the agent 118 or the delivery person 130 physically interacting with the locker 108 (or an interface of the locker computing device 116) or by using the agent application 119 on the agent computing device or a delivery application 132 on a delivery person device 134, respectively. Other details regarding unlock code setting are described below with respect to FIGS. 7 to 13.

For instance, FIGS. 7 to 13 describe an example scenario in which an unlock code is generated for an order (e.g., by the server device 112 or the locker computing device 116) and provided to the delivery person 130 (e.g., as meta information associated with a delivery). The delivery person 130 can use the unlock code to unlock the locker 108. The locker computing device 116 can record the entry of the unlock code by the delivery person 130 as a first entry and maintain the unlock code for the locker 108. The user 102 can also use the unlock code to unlock the locker 108 and then retrieve a delivered item from the unlocked locker. The locker computing device 116 can detect the entry of the unlock code by the user 102 as a second entry of the unlock code, enable the unlocking of the locker 108, but then delete (or trigger deletion of) the unlock code for the locker 108 so that the locker 108 is available for other deliveries.

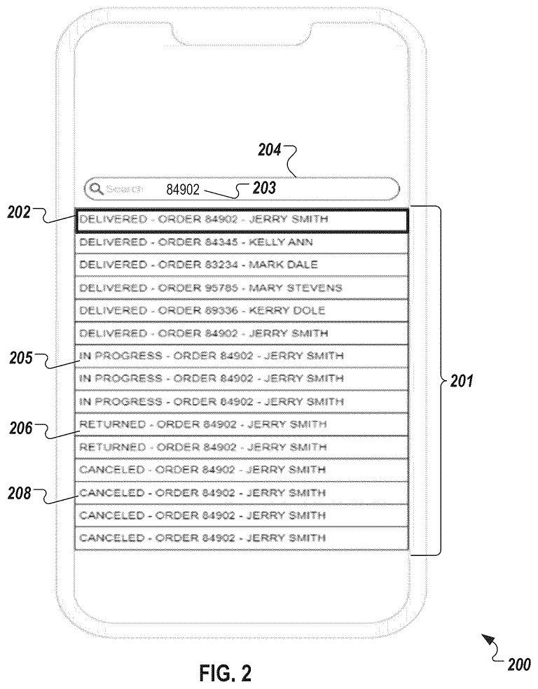

FIG. 2 illustrates an example order selection user interface 200 of an agent application (e.g., the agent application 119) that enables the agent 118 to search for and/or to select a particular order number. Order items that the agent may select or interact with are displayed in the user interface 200 in an order list 201. For example, the agent 118 can select an order item 202 corresponding to an order “84902” in response to being told the order number (or in some cases, the name of the user 102). For example, the agent may enter an order number 203, as shown, into a search box 204, which can cause the order item 202 to appear in the order list 201 (and in some cases, cause other order items not matching the search to be hidden from the order list 201). As another example, in some implementations, in response to the user 102 entering an initial code at the locker computing device 116, the agent application 119 can be notified that a user is attempting to retrieve a particular order and the order can be pre-selected or otherwise highlighted in the user interface 200 (e.g., as shown by a highlighted style used for the order item 202). The agent application 119 can receive notifications sent from the server device 112 (or in some cases, from the locker computing device 116, for example).

The user interface 200 currently shows order items of orders that have various statuses. For example, the order corresponding to the order item 202 has a status of delivered. Orders corresponding to other order items 205, 206, and 208 have order statuses of in progress, returned, and cancelled, respectively. An in-progress status for an order can indicate that placing one or more items of the order into a locker is in progress (or that delivery of the item to the location of the locker is in progress). A cancelled status for an order can indicate that the user or user has cancelled an order and therefore won't be (and won't be able to) retrieve item(s) from the order from a locker.

A returned status for an order can indicate that item(s) in a locker correspond to items a user is returning to (or has returned) to a merchant. A return process can involve a user receiving a code to open a locker (similar to the processes described herein for receiving a code to unlock a locker for retrieving an item) so that after opening the locker the user can place the item in the locker. In some cases, the user is instructed to find and notify an agent so that the agent can mark an item as returned. In some cases, the agent is able to obtain a code to open the locker to verify that an item has been place by the user into the locker. Delivery personnel who arrive to place items in lockers can retrieve items to be returned from lockers that have been used to store returned items. Allowing use of lockable lockers for returning unopened age-restricted items can enable maintaining control of age-restricted items to prevent unauthorized (e.g., underage) access to items that are being returned.

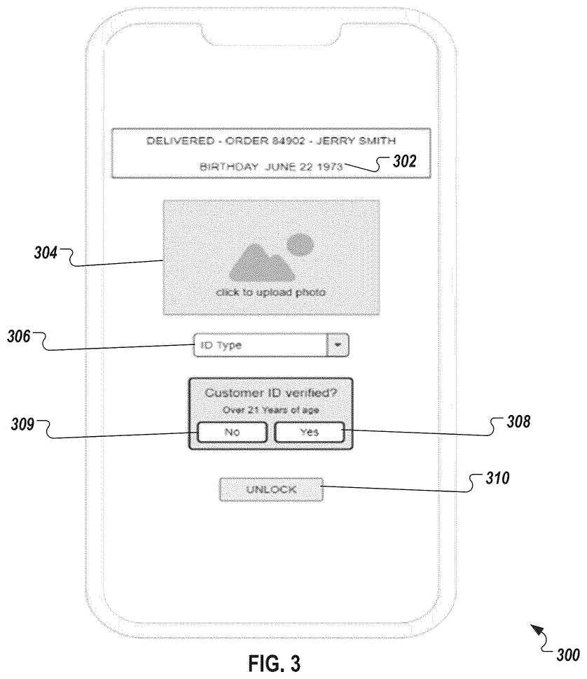

FIG. 3 illustrates an example age-verification user interface 300 of an agent application (e.g., the agent application 119) that enables the agent 118 to perform an age verification process with the user 102 for an order. For example, the user interface 300 can be displayed in response to agent selection of the order item 202 (corresponding to order number 84902) in the user interface 200 of FIG. 2. In response to determining that the order is for or includes at least one age-restricted item, the agent 118 can ask the user 102 for identification for the age verification process. The user 102 can provide identification (e.g., a driver's license or some other form of appropriate and age-confirming identification) to the agent 118. The agent 118 can inspect the identification to verify the identity and age of the user 102. That is, the agent 118 can visually verify that the appearance of the user matches a photograph of the user 102 on the identification and that an age of the user 102 included on the identification meets the age restriction.

Different approaches can be used to record and/or finalize the identity/age verification. For instance, the agent 118 can manually enter, in the user interface 300, the age (or a birthdate that can be used to determine a current age) of the user 102 that the agent sees on the identification. For instance, the user interface 300 includes a birthday value 302 that the agent 118 may have previously entered using the user interface 300. As another example, the agent 118 may use the agent device 120 to capture an image of the identification. A captured image 304 of the identification can be displayed in the user interface 300. The agent 118 can select the captured image 304 (or another user interface control, such as an “upload” button) to upload the captured image 304, e.g., to the server device 112 or another server. The agent 118 can select an identification type using an identification type selection list 306. Selectable identification types can include driver's license, passport, military identification, other government-provided identification, and/or other identification types. The selected identification type can be uploaded along with the captured image. In some cases, additional verification is performed on a captured identification image after the image is uploaded, such as a verification process that determines that the identification appears to be authentic, that an age automatically extracted from the captured image via OCR (Optical Character Recognition) meets the age requirement, that information on the identification image matches information in a government database, etc. In some cases, the agent 118 finalizes the age/identity verification by selection an option (e.g., a “Yes” button 308) to confirm that the agent has verified the user identification. As another example, if the agent selects, for instance, a “No” button 309, such as if an age on the provided identification is not a sufficient age or if the identification does not include a visible age, the item retrieval process can end and the agent can inform the user that they are not allowed to retrieve the item from the locker. In some implementations, the user interface 300 enables the agent 118 to capture a signature of the user 102. The user interface 300 can include an area that enables capture of a signature, using touch or other input (e.g., a stylus), for example. The agent 118 can show the agent device to the user 102 so that the user 102 can sign their signature on the agent device. An image of the captured signature can be uploaded along with the image of the identification of the user 102.

In some cases, an uploading of a captured identification image by the agent 118, and/or a selection of the “Yes” button 308 triggers an unlock process for the item 110. In other cases, the agent 118 can select another option such as an unlock button 310 to trigger the unlock process. In some cases, such as where the locker bank 104 is in close proximity to a retail counter (e.g., next to or perhaps behind the counter), the triggering of the unlock process can result in automatic unlocking of the locker 108 to enable retrieval of the item (e.g., by the agent 118 or the user 102). For instance, the locker computing device 116 may receive an unlock message for the item 110 from the server device 112 (or in some cases, such as in P2P (Peer to Peer) networks, from the agent device 120).

In general, however, the unlock process may generally include a transmission of an unlock code to the user 102/user device 114 to enable the user 102 to provide the unlock code to the locker computing device 116 (e.g., as an entered or scanned code or as a transmitted code transmitted from the user device 114 using NFC) to enable the user 102 to retrieve the item 110 from the locker 108. The locker computing device 116 can, upon receipt and verification of the unlock code), trigger an unlock of the locker 108, for example.

In some implementations, along with providing the unlock code, the user device 114 of the user provides information for verification. For example, the user device 114 can be a mobile device that can provide location information for the user device 114 (e.g., to an application running on the user device 114 and/or to a central server such as the server device 112 or another server). A verification can be performed to validate that the location of the user device 114 matches the geographic location of the locker bank 104, before the unlock code is generated and provided to the user. In other cases, the user device 114 can provide information, such as a device identifier, to the locker computing device 116 when in proximity to the locker computing device 116, as additional verification information for the user along with an unlock code.

Different approaches can be used for unlock code generation. For example, the agent application 119 can generate an unlock code and transmit the unlock code to the locker computing device 116 and/or to the server device 112. As another example, the locker computing device 116 itself may generate the unlock code. As yet another example, the unlock code may be generated by the server device 112. After the unlock code is generated, the unlock code can be communicated to the user 102/user device 114 (e.g., in a SMS (Simple Message Service) message, as a push notification, in an e-mail message, as an in-application message in the user application 103, etc. The unlock code can be communicated to the agent device 120, the locker computing device 116, and/or the server device 112 as appropriate, e.g., by whatever device actually generates the unlock code. Preferred embodiments can include server-side unlock code generation by the server device 112. Communication of the unlock code between devices occurs over secured channels.

As mentioned, after receiving the unlock code, the user 102/user device 114 can provide the unlock code to the locker computing device 116, to initiate unlocking of the locker 108 and to enable retrieval of the item 110. The locker computing device 116 can verify the unlock code before triggering unlocking of the locker 108. The locker computing device 116 can verify that the unlock code provided by the user 102/user device 114 matches an unlock code previously provided to the locker computing device 116 for the item 110 by the server device 112, for example. As another example, upon receiving the unlock code, the locker computing device 116 may send a request to the server device 112 to confirm validity of the unlock code for the item 110. As yet another example, if the locker computing device 116 itself generates unlock codes, the locker computing device 116 can verify a received unlock code for the item 110 against an unlock code previously-generated by the locker computing device 116 for the item 110.

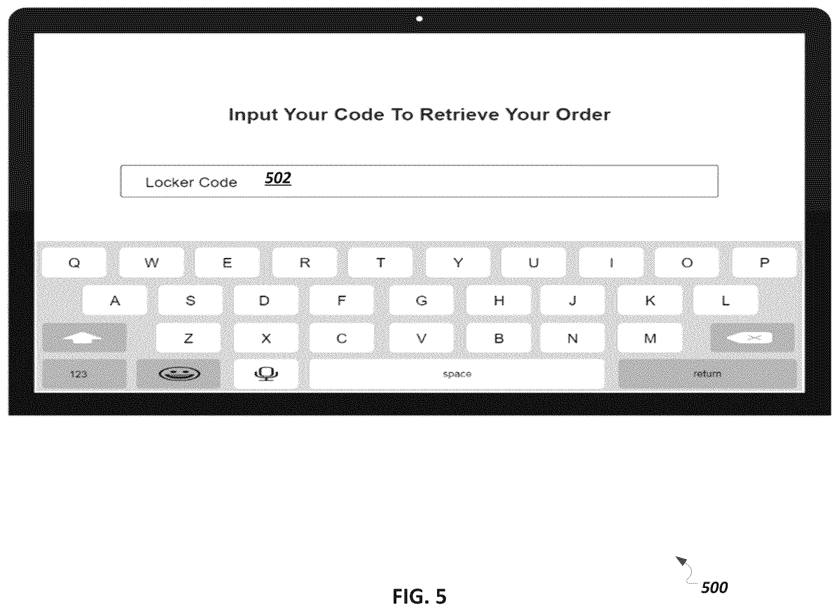

For implementations in which the locker computing device has a display, the locker computing device 116 can update the display to include informative messages for the user 102, such as for prompting to enter the unlock code (e.g., as shown, in FIG. 5, in an example user interface 500 that includes an entry field 502 for receiving an entered unlock code), communicating user-provided unlock code validity/invalidity, notifying that the locker 108 has been opened, directing the user 102 to the locker 108, etc. Upon opening of the locker 108, the locker computing device 116 may send update messages or communications, e.g., to the server device 112, for delivery/item pickup tracking, etc.

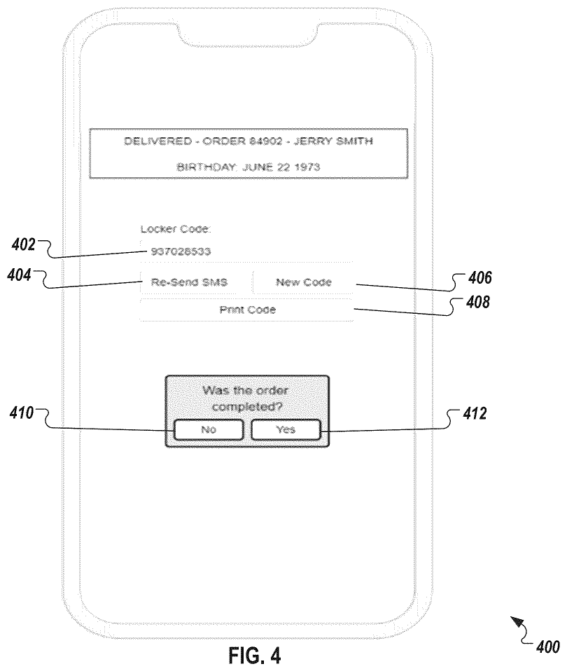

FIG. 4 illustrates an example user interface 400. The user interface 400 is displaying information for an order 84902. The user interface 400 can be displayed on the agent device 120, for example, in response to agent selection of the unlock button 310 described above with respect to FIG. 3. The agent 118 can do various code management activities related to a generated unlock code, using the user interface 400. A current unlock code 402 for the order 84902 of the user 102 is displayed in the user interface 400. If the user 102 has a problem using the unlock code, the user 102 can ask the agent 118 for assistance. The agent 118 can, for example, select a re-send SMS button 404 to trigger resending of the unlock code to the user 102/user device 114 as an SMS message. As another example, the agent 118 can select a new-code button 406 to trigger regeneration of a new unlock code (and a resending of the new unlock code to appropriate devices, including, for example, the user device 114). As yet another example, the agent 118 can select a print-code button 410 to trigger printing of the unlock code (e.g., on a slip to be provided to the user 102). The retailer location 106 can include a printer that is communicatively coupled to the agent device 120, for example. The agent 118 can select a “No” button 410 to record that the order was not completed (e.g., if the user 102 continues to have a problem retrieving the item 110, such as if the locker bank 104 malfunctions). In some cases, the agent 118 can select a “Yes” button to record successful completion of the order. However, in some cases previous triggering of the unlock code generation can be treated as order completion.

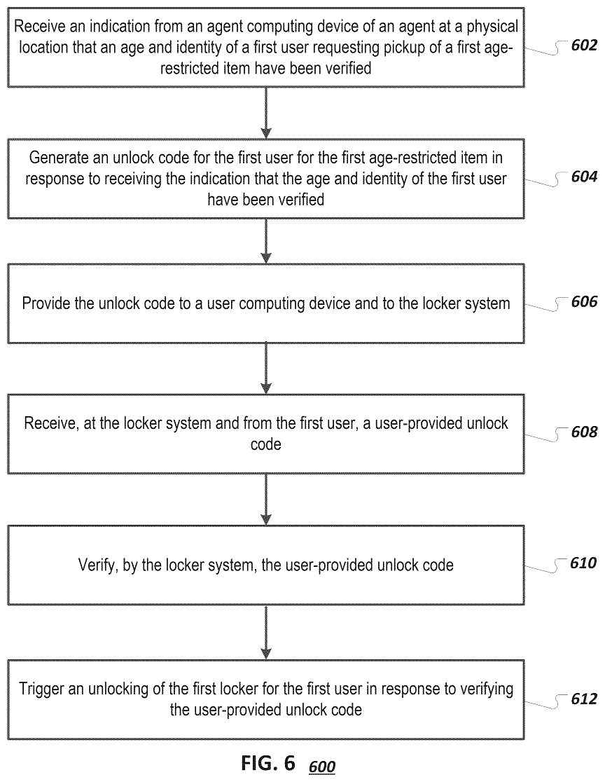

FIG. 6 is a flowchart of an example method 600 for controlling access to a parcel locker for age-restricted items. It will be understood that method 600 and related methods may be performed, for example, by any suitable system, environment, software, and hardware, or a combination of systems, environments, software, and hardware, as appropriate. For example, one or more of a client, a server, or other computing device can be used to execute method 600 and related methods and obtain any data from the memory of a client, the server, or the other computing device. In some implementations, the method 600 and related methods are executed by one or more previously described components. For example, the method 600 and related methods can be executed by component(s) of the system 100 of FIG. 1.

At 602, an indication is received from an agent computing device of an agent at a physical location that an age and identity of a first user requesting pickup of a first age-restricted item have been verified. The indication can be received at the agent device 120 of the agent 118, for instance. The physical location can be the retailer location 106 of FIG. 1, for example. The physical location includes a locker system that includes a first locker that includes the first age-restricted item that was delivered to the first locker. For example, the item 110 is included in the locker 108 of the locker bank 104. The agent can verify the age and identity of the first user by inspecting identification (e.g., an identification card, such as a driver's license) of the first user. Receiving the indication can include the agent capturing an image of the identification card and uploading the image of the identification card to a central system. For example, the agent 118 can use the user interface 300 to capture an image of the identification and trigger an upload of the captured image to the server device 112. As another example, the agent can select an option in an agent application to confirm that the agent has verified the identification and the indication can be sent to the central system in response to the selection without the central system receiving an image of the identification. The identification can include a driver's license or other state identification, or a military identification card. The indication can include the identification type. In some implementations, other forms of identification can be used, such as different types of digital information. In some cases, biometric information can be obtained from the first user and used to verify the identity of the user (and in some cases the age of the user by matching the received biometric information to known biometric information about the first user that is mapped to, for example, a birthdate of the first user).

At 604, an unlock code is generated for the first user for the first age-restricted item in response to receiving the indication that the age and identity of the first user have been verified. The unlock code can be generated by a central server (e.g., the server device 112), the locker system (e.g., the locker computing device 116), or the agent computing device (e.g., the agent device 120). As described in more detail below, the unlock code can have an associated expiration time (e.g., the unlock code may expire five minutes after the unlock code is generated).

In some implementations, a secondary verification of identification provided by the user can be performed (e.g., by the central server or the locker system) before the unlock code is generated. The secondary verification can include automatically extracting a user birth date of the first user from an image of the identification and automatically verifying the age of the user based on the extracted birth date. The secondary verification can include analyzing an image of the identification to verify authenticity of the identification.

At 606, the unlock code is provided to a user computing device and to the locker system. For example, the unlock code can be provided to the user device 114 and the locker computing device 116. The unlock code user can be provided to the user computing device using a SMS message, an in-application message, an electronic mail message, or a push message. In some instances, local transfer protocols may be used to provide the unlock code, e.g., from a point-of-sale or computing device local to the locker system.

At 608, a user-provided unlock code is received from the first user at the locker system. For example, the locker computing device 116 can receive the unlock code from the user 102. The unlock code can be received at the locker system as touch inputs of an input device of the locker system. The unlock code can be received at the locker system in response to receiving an image of the unlock code at an image scanner of the locker system. The locker computing device 116 can scan an unlock code image that is displayed on the user device 114, for example, or an unlock code image that the user 102 has received on a printed slip obtained from the agent 118. The unlock code can be received at the locker system over a wireless network from the user computing device (e.g., the user device 114). Any suitable wireless data transfer technology can be used as well to transfer information between the user computing device and the locker system, or to initially provide the unlock code to the user computing device. For example, Bluetooth, WiFi, Zigbee, NFC, or other suitable wireless transmission protocols may be used in some instances so that the unlock code can be provided to the locker system.

At 610, the locker system verifies the user-provided unlock code. For example, the locker computing device 116 can verify that the user-provided unlock code matches the unlock code previously-provided to the locker computing device 116 and that the unlock code is still valid (e.g., has not expired).

At 612, an unlocking of the first locker for the first user is triggered in response to verifying the unlock code (e.g., in response to determining that the unlock code received from the first user matches the unlock code previously-provided to the locker system and that the unlock code has not expired). For example, the locker computing device 116 can trigger an unlocking of the locker 108 of the locker bank 104. The first user can retrieve the first age-restricted item from the first locker after the first locker has been automatically opened for the first user. For example, the user 102 can remove the item 110 from the locker 108 once the locker 108 has been unlocked.

In some implementations, information can be logged in response to the triggering of the unlocking of the first locker. In some implementations, a request can be received from the agent computing device to regenerate a new unlock code. A second unlock code can be generated in response to the request to regenerate the new unlock code and the second unlock code can be provided to the user computing device, the agent computing device, and the locker system. Regeneration of the second unlock code can invalidate the first unlock code.

Although agent verification of user identity and age is described, in some implementations, a user may interact with one or more on-site devices, rather than an agent, for age and identity verification. For example, the user may interact with the locker system itself, or with a device communicatively-connected to the locker system (e.g., a kiosk) for age and identity verification. For example, the locker system or the kiosk can include one or more scanners and/or cameras that can be used to verify the user's age and identity. For instance, the locker system or the kiosk can prompt the user (e.g., after the user enters some initial information such as a name, user account number, and/or order number) to scan the user's identification (e.g., driver's license card or other identification card) using a scanner or camera of the locker system or kiosk to proceed with pickup of an age-restricted item. For instance, the user may be prompted to insert their identification card (to be scanned by an internal scanner or camera) or the user may be prompted to hold up their identification card in front of a scanner or camera.

The locker system or kiosk can automatically extract textual information from the scanned identification card, such as name and birthdate or age information displayed on the card. As another example, the locker system or kiosk can send a captured image of the identification card to a central server for server-side text extraction. The locker system, kiosk, or server can determine whether the extracted age meets age requirements for pickup of an age-restricted item. The locker system, kiosk, or server can also extract name information from the image of the identification card and automatically determine whether an extracted name matches an expected name associated with the order.

In some implementations, the locker system, kiosk or server can perform other validations on the captured image of the identification card. For example, the locker system, kiosk, or server can analyze the image to identify an identification issuer of the identification card (e.g., an identification issuer corresponding to a certain jurisdiction, such as a state or province (e.g., the state of Minnesota, USA)). The locker system, kiosk, or server can verify that the captured image is an image pattern (e.g., overall image pattern plus user information) that matches an expected image pattern corresponding to identifications issued by the identification issuer. For example, the locker system, kiosk, or server can determine that the captured image appears to be a drivers license issued by the state of Minnesota and that the captured image matches an image pattern included on Minnesota drivers licenses.

In some implementations, the locker system or kiosk can capture an image of the user standing in front of the locker system or kiosk (e.g., after prompting the user to face a camera included in the locker system or kiosk). As with the captured image of the identification card, the locker system, kiosk, or a central server (after receiving a user image) can evaluate the image of the user, e.g., for identification purposes. For example, a portion of the captured image (e.g., a head, a face) can be compared to a corresponding portion of a user image included in the identification card image, to determine if the captured user image appears to match the image of the user on the identification card. Other comparisons can be performed, such as comparing the captured user image to one or more known images of the user (e.g., as may be available in a government database).

After respective automatic age and identity verifications have been performed by the locker system, kiosk, or server, age and identity verification results can be shared between systems, as appropriate for a given implementation. For example, in implementations in which a kiosk is communicatively coupled with the locker system, any verification results performed by the kiosk can be shared with the locker system and/or a central server. Similarly, if one or both of automatic age or identity verification have been performed by the locker system or central server, respective verification result(s) can be communicated to the other of the locker system or server. If both age and identity have been automatically verified, locker unlocking procedures can be triggered and/or initiated, using one of the approaches described above.

FIGS. 7-12 illustrate example screenshots related to a computer-implemented methods, software, and systems for controlling access to a locker bank. In these examples, a recipient can elect to receive a package using the illustrated system (e.g., via the UI of FIG. 7), and can direct or indicate to a delivery service or person to deliver an item to a particular locker while providing a secure code for a specific locker. In some instances, the locker can be associated with a locker system (e.g., the locker computing device 116), which can program and/or set lock codes and passwords for particular lockers. As an example and as shown in FIG. 7, the user can be presented with a user interface 700 and can select a button 702 to trigger initiation of a process for receiving a package at a locker system.

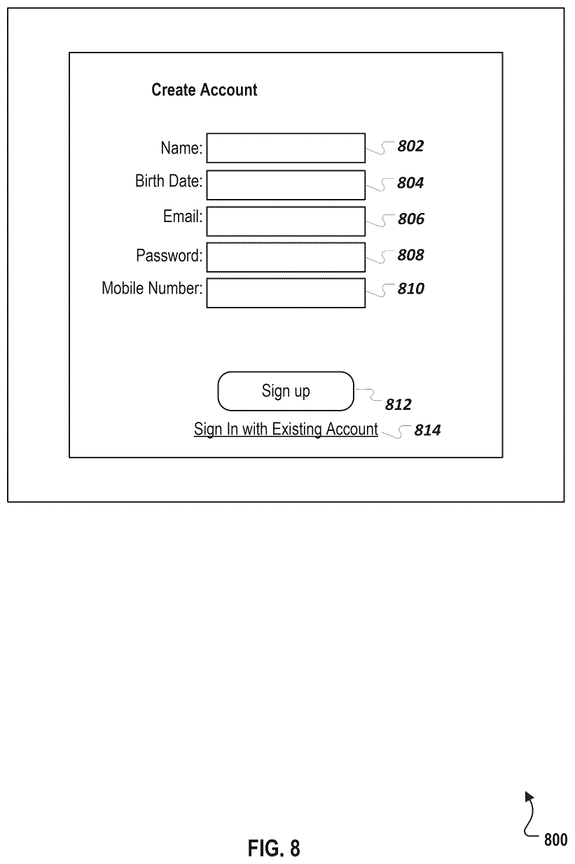

As illustrated in FIG. 8, a user interface 800 can be provided for the recipient to create a new account with the locker system, and/or sign in to an existing account. The user interface 800 can be displayed to the user 102 in the user application 103 on the user device 114, for example. The user interface 800 includes name 802, birth date 804, email 806, password 808, and mobile number 810 entry fields that enable a user to provide user information for a new account. The user can select a sign up button 812 to trigger sending of the user information to a central system (e.g., the server device 112) to request creation of a new user account. As another example, the user can select a link 814 to sign in to an existing user account. In some instances, other user information or preferences can be saved and stored for users, and can include relevant information such as preferred or recent locker locations, payment information, and other user-specific information.

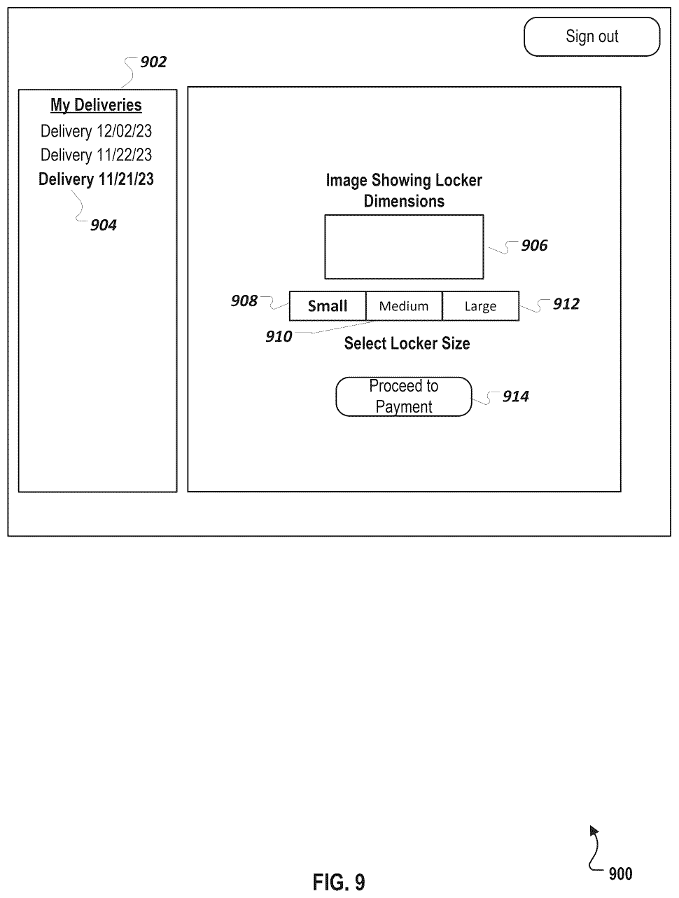

Once logged in, FIG. 9 illustrates a locker selection page. Multiple deliveries may be selectable in a delivery list 902, and, for one or each of the deliveries, a particular size or type of locker can be selected. For instance, as shown in FIG. 9, the user has selected a delivery 904. In some instances, a representative image 906 of a corresponding locker that will be (or has been) used for the delivery 904 can be displayed, along with other locker characteristics in some cases. In some implementations and/or for some types of deliveries, the user can select a locker size or other locker characteristics. For example, the user interface 900 includes selectable small 908, medium 910, and large 912 options. The small option 908 is currently selected (and correspondingly, the representative image 906 is of a small locker currently selected for the delivery 904. In some instances, information about a delivery may be used to determine if a particular locker is suitable for the delivery. For example, if a delivery includes refrigerated items, then a refrigerated locker may be required (and may be automatically selected). Or, in some cases, the user may be able to select from different sizes of refrigerated lockers. As another example, if a delivery is associated with a defined size (e.g., based on item(s) in the delivery), then a corresponding locker will need to be used that can accept deliveries of the defined size. In such examples, a predetermined size of locker may be automatically selected or the user may be able to select from certain locker types that are capable of holding the item(s) of the delivery 904, given the known size of the item(s).

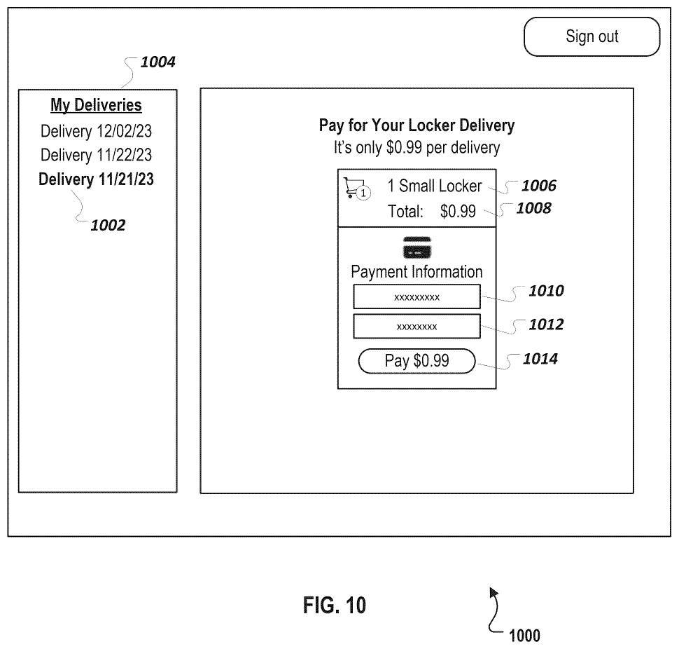

Once a particular locker type is selected, a payment page can be presented (e.g., in response to selection of a proceed-to-payment button 914), as shown in a user interface 1000 in FIG. 10. The recipient can input new payment information or used saved payment information to complete the transaction and secure a particular locker. In some instances, the locker may be provided free to the recipient, such as when retailers or other providers offer free shipping or delivery, or when those retailers or providers have agreements with locker providers.

In further detail, the user can use the user interface 1000 to perform payment activities for a delivery item 1002 included in a deliveries list 1004. A locker size indication 1006 indicates that the user is paying for a small-sized locker. A price indication 1008 indicates that a cost of a small-sized locker is $0.99. Payment information areas 1010 and 1012 display payment information details. For instance, the user may have entered, selected, or provided payment account information, such as payment account number, expiration date, security code, etc. The user can submit a payment for $0.99 for the small-sized locker by selecting a pay button 1014.

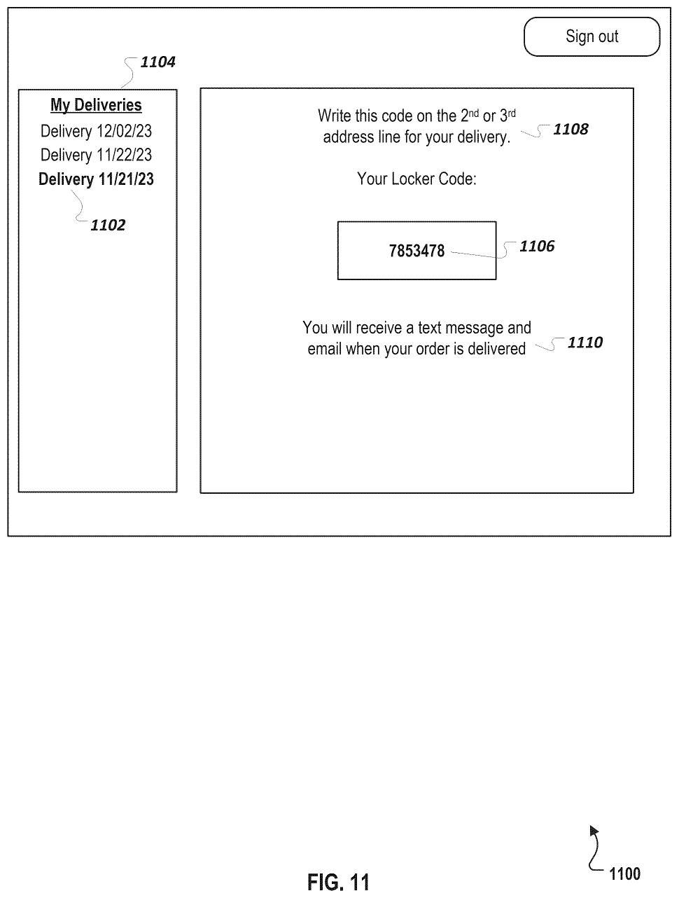

FIG. 11 illustrates a user interface 1100 that can be provided to the recipient once payment has been provided or otherwise confirmed. As another example, the user interface 1100 can be provided after the user selects or is assigned a particular locker (such as when the user is not required to pay for the locker). A central server or website, for example, can generate and display, for a selected delivery item 1102 in a delivery list 1104, a unique code 1106 or other identifier that can be assigned to the locker as the specific unlock code of the locker to be used in the delivery. As illustrated, where a third party is delivering the package or item, the user interface 1100 can direct, using a note 1108, the recipient to include the locker code in delivery instructions for the package or in secondary (e.g., second or third line) address information for an order that includes the item(s) to be delivered. That is, in some instances, providing the code to a third party can include entering the code into an address line of a delivery address, while in other instances, providing the code to the third party may include leaving digital instructions for the delivery person via a website or app associated with the delivering third party. In some instances, the locker code may automatically get added to delivery information when delivery services and the locker system website collaborate or share information about particular deliveries.

In addition to the locker code being provided in the user interface 1100 of FIG. 11, the locker code can also be provided to the locker system and can be associated with a corresponding locker. The transmission of the generated code can be sent by the website or an associated application to the locker system, or in some cases, to a specific locker having a defined address and corresponding to the selected locker. The locker can be assigned the corresponding locker code as a password. In some instances, the locker can be associated with the code, but may only be activated and locked with the unique password on a day or time when the delivery is to occur, thereby avoiding the possibility that particular lockers are reserved without use while waiting for a package.

Once assigned the locker code, the locker—in some instances via the locker system or server—can follow a set of logic and/or rules for proceeding with the delivery. In one example, when a locker code is used for the first time at the locker, the locker is unlocked. This instance corresponds to the delivery operation, where the delivery person enters the code and places the delivery item inside the locker.

When the locker is then closed, the same locker code can be stored and maintained at the locker until a second use of the locker code is performed. Additionally and as indicated in a note 1110, a text message or other suitable notification can be sent, automatically in response to the first code usage, from the locker and/or the locker system to the recipient. The message or notification can notify the recipient of their order's availability, and a reminder of the code associated with the delivery. The recipient can then visit the locker and use the locker code to obtain the delivery.

Once the locker is opened a second time using the locker code, a message can be sent to the central server or website to record the transaction under the recipient's account, and finalize the transaction. Additionally, the locker code can be deleted from the locker after its second use, allowing the locker to be reused by others.

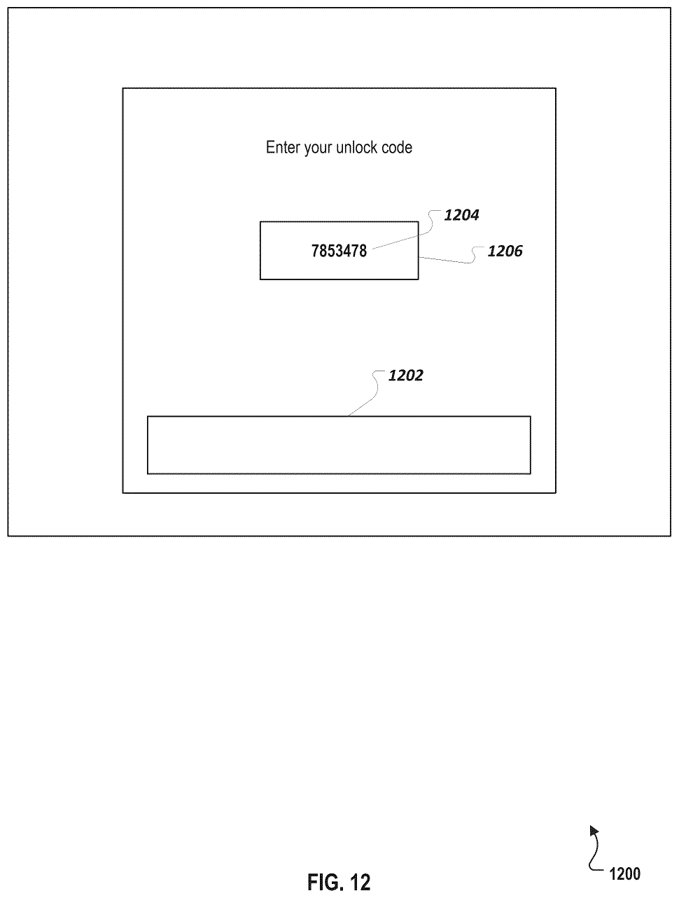

FIG. 12 illustrates a locker user interface 1200 that can be presented at a particular locker, or at a centralized location or computer in a locker location. A number pad 1202 or other entry mechanism can be available with the user interface 1200 to enter the unique code (e.g., as illustrated by an entered code 1204 displayed in a code area 1206) to enable opening of the locker. As indicated above, the delivery person can enter the unique code a first time via the user interface 1200, and the locker can open. The locker system can detect that the entry of the code by the delivery person is a first entry of the code for the locker, and can maintain the same locker code for the locker until a second entry of the code is received (e.g., by the recipient). In response to the second entry of the locker code (e.g., by the recipient), the locker system can unlock and allow access to the locker, but then can reset (or clear) the lock code for the locker after the locker is closed. In response to the lock code for the locker being reset or cleared, the locker can be identified (e.g., by a locker server or system) as being again available for other deliveries for future recipients.

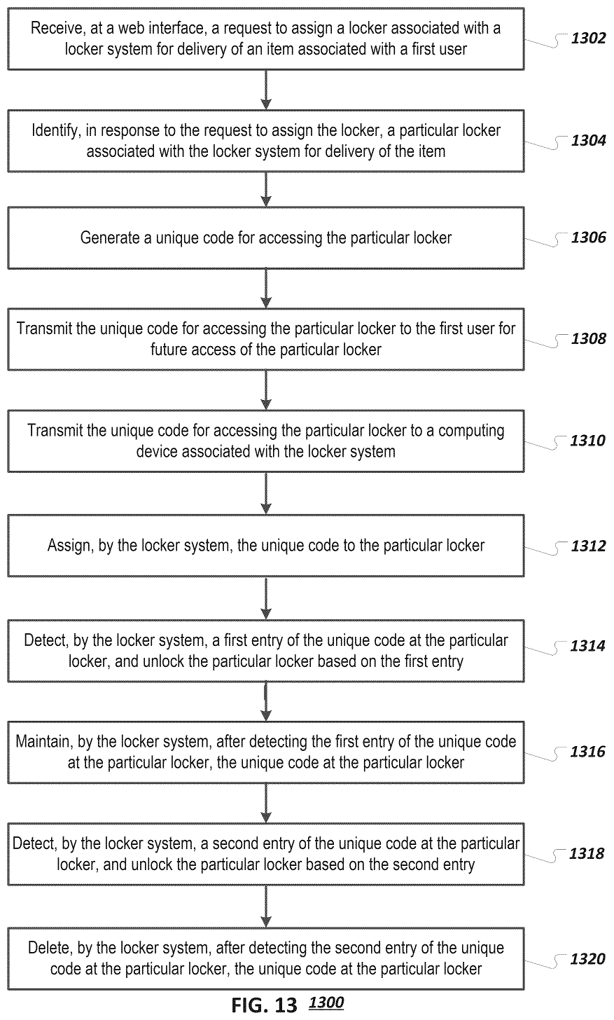

FIG. 13 is a flowchart of an example method 1300 for controlling access to a parcel locker for age-restricted items. It will be understood that method 1300 and related methods may be performed, for example, by any suitable system, environment, software, and hardware, or a combination of systems, environments, software, and hardware, as appropriate. For example, one or more of a client, a server, or other computing device can be used to execute method 1300 and related methods and obtain any data from the memory of a client, the server, or the other computing device. In some implementations, the method 1300 and related methods are executed by one or more previously described components. For example, the method 1300 and related methods can be executed by component(s) of the system 100 of FIG. 1.

At 1302, a request is received, at a web interface, to assign a locker associated with a locker system for delivery of an item associated with a first user. For example, a server device (e.g., the server device 112) can receive a request, from the user device 114, to assign a locker for delivery of the item in response to the user 102 selecting the button 702 on the user interface 700 of FIG. 7 that may be displayed in the user application 103.

At 1304, a particular locker associated with the locker system for delivery of the item is identified, in response to the request to assign the locker. For example, the server device 112 or the locker computing device 116 can identify the locker 108 for delivery of the item. In some cases the server device 112, the locker computing device, or another system or server can identify the locker 108 based on characteristics of the item and/or based on user selection(s) (such as locker size) that the user 102 may have made on a user interface such as the user interface 900 of FIG. 9.

At 1306, a unique code is generated for accessing the particular locker. For example, the server device 112 can generate a unique unlock code for the locker 108. In some implementations, the locker computing device 116 can generate the unique unlock code.

At 1308, the unique code for accessing the particular locker is transmitted to the first user for future access of the particular locker. For example, the server device 112 or the locker computing device 116 can transmit the unique unlock code for the locker 108 to the user 102 (and the user 102 can view the unique unlock code (e.g., in an SMS message, an email message, an in-application message) on the user device 114).

At 1310, the unique code for accessing the particular locker is transmitted to a computing device associated with the locker system. For instance, in examples in which the server device 112 generates the unique unlock code for the locker 108, the server device 112 can transmit the unique unlock code for the locker 108 to the locker computing device 116. As another example, in some implementations, the locker 108 itself has a separate associated computing device separate from the locker computing device 116. For instance, each locker of the locker bank 104 may be or include a computing device that can communicate with a central locker computing device 116 that provides overall management of the locker bank 104. In such examples, the locker computing device 116 can generate the unique code and transmit the code to the locker 108. In other examples, the locker computing device 116 can receive the unlock code from the server device 112 and then forward the unique code to the locker 108.

At 1312, the locker system assigns the unique code to the particular locker. As mentioned above, the locker computing device 116 can, in some cases, send or forward the unique code to the locker 108. In other implementations, the locker computing device 116 can store an assignment of the unique code to the locker 108 in memory of the locker computing device 116.

At 1314, the locker system detects a first entry of the unique code at the particular locker and unlocks the particular locker based on the first entry. For example, the locker bank 104 can be configured so that the locker computing device 116 receives user input information regarding an inputted unlock code for the locker 108 (e.g., using a graphical user interface of the locker computing device 116 or in response to a physical hardware code input mechanism associated with the locker 108 or the locker bank 104 itself). As another example, the locker 108 itself can receive user code input for the locker 108 and provide the inputted code to the locker computing device 116. In some cases, the inputted code is evaluated at the locker computing device 116. In other implementations, the locker computing device 116 provides the inputted code to the server device 112 and the server device 112 evaluates the inputted code on behalf of the locker bank 104. The locker computing device 116 or the server computing device 112 can determine that the inputted code matches the code assigned to the locker 108. If the server computing device 112 determines that the inputted code matches the code assigned to the locker 108, the server computing device 112 can send a notification to the locker computing device 116 that the inputted code matches the code assigned to the locker 108. The locker computing device 116 can send an instruction to or for the locker 108 (or trigger activation of a mechanism in the locker bank 104) that results in the locker 108 being opened. While the locker 108 is open in response to the first entry of the unique code, a delivery person (e.g., the delivery person 130) can place the item to be delivered in the locker 108.

At 1316, the locker system maintains the unique code at the particular locker after detecting the first entry of the unique code at the particular locker. For example, the locker computing device 116 can store and maintain an indication that a first entry of the unique code has been received at or for the locker 108 after the unique code has been generated for the locker 108, until a second entry of the unique code is received for the locker 108 (e.g., where the second entry can correspond to a recipient entering the unique code to open the locker 108 to retrieve the item from the locker 108).

At 1318, the locker system detects a second entry of the unique code at the particular locker and unlocks the particular locker based on the second entry. For example, the user 102 who had previously received the unique code (e.g., in an SMS or email message, etc.) can enter or otherwise provide the unique code at the locker 108 (or more generally at the locker bank 104 or at an interface of the locker computing device 116, using various means, as described above). Similar to detection of the first entry of the unique code, the locker computing device 116, the locker 108, and/or the server device 112 can detect and evaluate the second entry of the unique code and determine that the second entry matches the unique code being maintained for the locker 108 at the locker computing device 116. The locker computing device 116 can trigger opening of the locker 108, using various means as described above, based on the second entry of the unique code matching the unique code being maintained for the locker 108. The opening of the locker 108 in response to the locker computing device 116 determining that the second entry of the unique code matches the unique code being maintained for the locker 108 can enable the user 102 to retrieve the item being held in the locker 108.

At 1320, the locker system deletes the unique code at the particular locker after detecting the second entry of the unique code at the particular locker. For example, the locker computing device 116 can either trigger a reset or unassignment of the unique code at the locker 108 itself and/or the locker computing device 116 can remove maintained/logged information regarding an assignment or maintenance of the unique code being assigned to the locker 108 that may have been stored at the locker computing device 116. In some cases, the locker computing device 116 can send an instruction to the server device 112 instructing the server device 112 to remove any mappings of the unique code to the locker 108 (or to the delivery in general). The server device 112 can delete information that maps the unique code to the locker 108 or the delivery in response to the instruction received from the locker computing device 116.

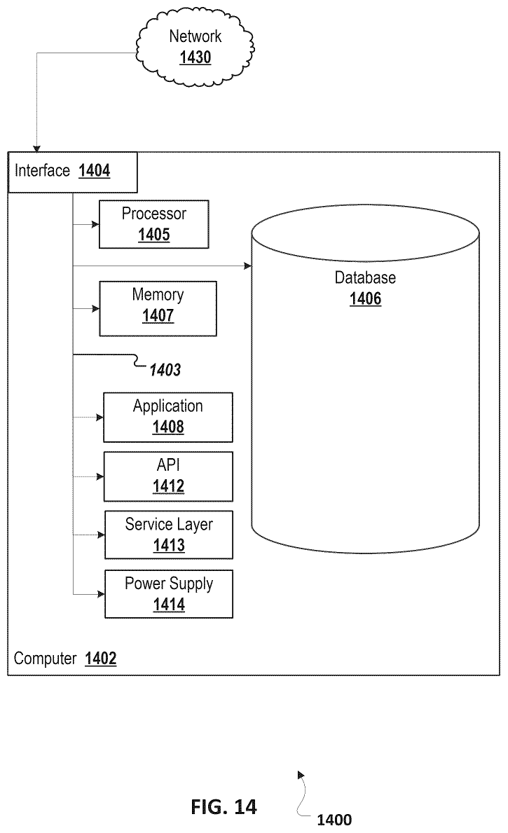

FIG. 14 is a block diagram illustrating an example of a computer-implemented System 1400 used to provide computational functionalities associated with described algorithms, methods, functions, processes, flows, and procedures, according to an implementation of the present disclosure. In the illustrated implementation, System 1400 includes a computer 1402 and a network 1430.

The illustrated computer 1402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the computer 1402 can include an input device, such as a keypad, keyboard, or touch screen, or a combination of input devices that can accept user information, and an output device that conveys information associated with the operation of the computer 1402, including digital data, visual, audio, another type of information, or a combination of types of information, on a graphical-type user interface (UI) (or GUI) or other UI.

The computer 1402 can serve in a role in a distributed computing system as, for example, a client, network component, a server, or a database or another persistency, or a combination of roles for performing the subject matter described in the present disclosure. The illustrated computer 1402 is communicably coupled with a network 1430. In some implementations, one or more components of the computer 1402 can be configured to operate within an environment, or a combination of environments, including cloud-computing, local, or global.

At a high level, the computer 1402 is an electronic computing device operable to receive, transmit, process, store, or manage data and information associated with the described subject matter. According to some implementations, the computer 1402 can also include or be communicably coupled with a server, such as an application server, e-mail server, web server, caching server, or streaming data server, or a combination of servers.

The computer 1402 can receive requests over network 1430 (for example, from a client software application executing on another computer 1402) and respond to the received requests by processing the received requests using a software application or a combination of software applications. In addition, requests can also be sent to the computer 1402 from internal users (for example, from a command console or by another internal access method), external or third-parties, or other entities, individuals, systems, or computers.

Each of the components of the computer 1402 can communicate using a system bus 1403. In some implementations, any or all of the components of the computer 1402, including hardware, software, or a combination of hardware and software, can interface over the system bus 1403 using an application programming interface (API) 1412, a service layer 1413, or a combination of the API 1412 and service layer 1413. The API 1412 can include specifications for routines, data structures, and object classes. The API 1412 can be either computer-language independent or dependent and refer to a complete interface, a single function, or even a set of APIs. The service layer 1413 provides software services to the computer 1402 or other components (whether illustrated or not) that are communicably coupled to the computer 1402. The functionality of the computer 1402 can be accessible for all service consumers using the service layer 1413. Software services, such as those provided by the service layer 1413, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the computer 1402, alternative implementations can illustrate the API 1412 or the service layer 1413 as stand-alone components in relation to other components of the computer 1402 or other components (whether illustrated or not) that are communicably coupled to the computer 1402. Moreover, any or all parts of the API 1412 or the service layer 1413 can be implemented as a child or a sub-module of another software module, enterprise application, or hardware module without departing from the scope of the present disclosure.

The computer 1402 includes an interface 1404. Although illustrated as a single interface 1404, two or more interfaces 1404 can be used according to particular needs, desires, or particular implementations of the computer 1402. The interface 1404 is used by the computer 1402 for communicating with another computing system (whether illustrated or not) that is communicatively linked to the network 1430 in a distributed environment. Generally, the interface 1404 is operable to communicate with the network 1430 and includes logic encoded in software, hardware, or a combination of software and hardware. More specifically, the interface 1404 can include software supporting one or more communication protocols associated with communications such that the network 1430 or hardware of interface 1404 is operable to communicate physical signals within and outside of the illustrated computer 1402.

The computer 1402 includes a processor 1405. Although illustrated as a single processor 1405, two or more processors 1405 can be used according to particular needs, desires, or particular implementations of the computer 1402. Generally, the processor 1405 executes instructions and manipulates data to perform the operations of the computer 1402 and any algorithms, methods, functions, processes, flows, and procedures as described in the present disclosure.

The computer 1402 also includes a database 1406 that can hold data for the computer 1402, another component communicatively linked to the network 1430 (whether illustrated or not), or a combination of the computer 1402 and another component. For example, database 1406 can be an in-memory or conventional database storing data consistent with the present disclosure. In some implementations, database 1406 can be a combination of two or more different database types (for example, a hybrid in-memory and conventional database) according to particular needs, desires, or particular implementations of the computer 1402 and the described functionality. Although illustrated as a single database 1406, two or more databases of similar or differing types can be used according to particular needs, desires, or particular implementations of the computer 1402 and the described functionality. While database 1406 is illustrated as an integral component of the computer 1402, in alternative implementations, database 1406 can be external to the computer 1402.

The computer 1402 also includes a memory 1407 that can hold data for the computer 1402, another component or components communicatively linked to the network 1430 (whether illustrated or not), or a combination of the computer 1402 and another component. Memory 1407 can store any data consistent with the present disclosure. In some implementations, memory 1407 can be a combination of two or more different types of memory (for example, a combination of semiconductor and magnetic storage) according to particular needs, desires, or particular implementations of the computer 1402 and the described functionality. Although illustrated as a single memory 1407, two or more Memories 1407 or similar or differing types can be used according to particular needs, desires, or particular implementations of the computer 1402 and the described functionality. While memory 1407 is illustrated as an integral component of the computer 1402, in alternative implementations, memory 1407 can be external to the computer 1402.

The application 1408 is an algorithmic software engine providing functionality according to particular needs, desires, or particular implementations of the computer 1402, particularly with respect to functionality described in the present disclosure. For example, application 1408 can serve as one or more components, modules, or applications. Further, although illustrated as a single application 1408, the application 1408 can be implemented as multiple applications 1408 on the computer 1402. In addition, although illustrated as integral to the computer 1402, in alternative implementations, the application 1408 can be external to the computer 1402.

The computer 1402 can also include a power supply 1414. The power supply 1414 can include a rechargeable or non-rechargeable battery that can be configured to be either user- or non-user-replaceable. In some implementations, the power supply 1414 can include power-conversion or management circuits (including recharging, standby, or another power management functionality). In some implementations, the power supply 1414 can include a power plug to allow the computer 1402 to be plugged into a wall socket or another power source to, for example, power the computer 1402 or recharge a rechargeable battery.

There can be any number of computers 1402 associated with, or external to, a computer system containing computer 1402, each computer 1402 communicating over network 1430. Further, the term “client,” “user,” or other appropriate terminology can be used interchangeably, as appropriate, without departing from the scope of the present disclosure. Moreover, the present disclosure contemplates that many users can use one computer 1402, or that one user can use multiple computers 1402.

The preceding figures and accompanying description illustrate example processes and computer-implementable techniques. But illustrated systems (or their software or other components) contemplate using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, illustrated systems may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method, comprising:
receiving an indication from an agent computing device of an agent at a physical location that an age and identity of a first user requesting pickup of a first age-restricted item have been verified, wherein the physical location includes a locker system that includes a first locker containing the first age-restricted item previously placed in the first locker;
generating an unlock code for the first user for the first age-restricted item in response to receiving the indication that the age and identity of the first user have been verified;
providing the unlock code to a user computing device and to the locker system;
receiving, at the locker system and from the first user, a user-provided unlock code;
verifying, by the locker system, the user-provided unlock code, wherein verifying the user-provided unlock code comprises:
verifying that the user-provided unlock code matches the unlock code previously provided to the locker system; and
verifying that the unlock code has not expired; and
triggering an unlocking of the first locker for the first user in response to determining that the unlock code received from the first user matches the unlock code previously provided to the locker system.

2. The computer-implemented method of claim 1, wherein the indication received from the agent computing device comprises an indication that the agent has verified the age and identity of the first user by visually verifying identification provided by the first user.

3. The computer-implemented method of claim 2, wherein the indication received from the agent computing device includes an image of the identification provided by the first user.

4. The computer-implemented method of claim 1, wherein the indication received from the agent computing device includes the age or a birth date of the first user entered by the agent into a user interface of the agent computing device.

5. The computer-implemented method of claim 1, wherein the indication received from the agent computing device includes an identification type of the identification provided by the first user, where identification types include driver license, other state-issued identification, or military-issued identification.

6. The computer-implemented method of claim 1, wherein the unlock code is generated by a central server or by the locker system.

7. The computer-implemented method of claim 1, wherein the unlock code is provided to the agent computing device.

8. The computer-implemented method of claim 7, wherein the unlock code is provided to the user computing device using a SMS (Simple Message Service) message, an in-application message, an electronic mail message, or a push message.

9. The computer-implemented method of claim 1, wherein the unlock code is received at the locker system as touch inputs of an input device of the locker system.

10. The computer-implemented method of claim 1, wherein the unlock code is received at the locker system in response to receiving an image of the unlock code at an image scanner of the locker system.

11. The computer-implemented method of claim 1, wherein the unlock code is received at the locker system, using wireless communication, from the user computing device.

12. The computer-implemented method of claim 1, wherein the generated unlock code is provided to the locker system for verification in response to the locker system requesting the unlock code after the locker system receives the user-provided unlock code.

13. The computer-implemented method of claim 1, further comprising:
performing a secondary verification of identification provided by the first user.

14. The computer-implemented method of claim 13, wherein the secondary verification comprises automatically extracting a birth date of the first user from an image of the identification and automatically verifying the age of the first user based on the extracted birth date.

15. The computer-implemented method of claim 13, wherein the secondary verification comprises analyzing an image of the identification to verify authenticity of the identification.

16. The computer-implemented method of claim 1, further comprising logging information in response to the triggering of the unlocking of the first locker.

17. The computer-implemented method of claim 1, further comprising:
receiving a request from the agent computing device to regenerate a new unlock code;
generating a second unlock code in response to the request to regenerate the new unlock code;
invalidating the unlock code; and
providing the second unlock code to the user computing device, the agent computing device, and the locker system.

18. A computer-implemented method, comprising:
receiving, at a web interface, a request to assign a locker associated with a locker system for delivery of an item associated with a first user;
in response to the request to assign the locker, identifying a particular locker associated with the locker system for delivery of the item;
generating a unique code for accessing the particular locker;
transmitting the unique code for accessing the particular locker to the first user for future access of the particular locker;
transmitting the unique code for accessing the particular locker to a computing device associated with the locker system;
assigning, by the locker system, the unique code to the particular locker;
detecting, by the locker system, a first entry of the unique code at the particular locker, and unlocking the particular locker based on the first entry;
after detecting the first entry of the unique code at the particular locker, maintaining, by the locker system, the unique code at the particular locker;
detecting, by the locker system, a second entry of the unique code at the particular locker, and unlocking the particular locker based on the second entry; and
after detecting the second entry of the unique code at the particular locker, deleting, by the locker system, the unique code at the particular locker.

19. The computer-implemented method of claim 18, further comprising:
in response to detecting, by the locker system, the first entry of the unique code at the particular locker:
transmitting a notification from the locker system to the first user of the delivery of the item.

20. The computer-implemented method of claim 19, further comprising:
in response to detecting, by the locker system, the second entry of the unique code at the particular locker:
transmitting a message to the web interface, the message indicating a complete delivery of the item associated with the first user.

21. The computer-implemented method of claim 18, wherein the item is an age-restricted item.

22. The computer-implemented method of claim 18, wherein the unique code for accessing the particular locker is transmitted to the first user after an age and identity of the first user have been verified.

23. The computer-implemented method of claim 18, wherein the unique code is generated by a central server.

24. The computer-implemented method of claim 18, wherein the unique code is generated by the locker system.

25. The computer-implemented method of claim 18, wherein the item is placed into the particular locker after the particular locker is unlocked based on the first entry.

26. The computer-implemented method of claim 18, wherein the item is removed from the particular locker after the particular locker is unlocked based on the second entry.
